(19) United States
(12) Patent Application Publication
(10) Pub. No.: US 2006/0027618 A1
(43) Pub. Date: Feb. 9, 2006

(54) ELECTRICAL GENERATOR CARRIER SYSTEM

(75) Inventor: Marty Williams, Colorado Springs, CO (US)

Correspondence Address: GLENN L. WEBB, P.O BOX 951, CONIFER, CO, 80433, US

(73) Assignee: LET'S GO AERO, INC., Colorado Springs, CO (US)

(21) Appl. No.: 11/160,087

(22) Filed: Jun. 8, 2005

Related U.S. Application Data
(63) Continuation-in-part of application No. 09/683,820, filed on Feb. 20, 2002.

(51) Int. Cl. B60R 11/00; B60R 7/00

(52) U.S. Cl. 224/519; 224/521; 224/566

(57) ABSTRACT

A carrier system for transporting portable electrical generators. The carrier of a preferred embodiment of the present invention includes a heat resistant deck for mounting the generator. The deck is attached to a receiver member that engages in a receiver hitch of a vehicle. A cover protects the generator from the environment as well as providing sound insulation for the operation of the generator.

### RELATED APPLICATIONS

This application is a continuation-in-part of Ser. No. 09/683,820, filed on Dec. 20, 2002.

### FIELD OF THE INVENTION

This invention relates to the field of transporting equipment, and particularly, to systems for transporting electrical generators.

### BACKGROUND OF THE INVENTION

The use of the interior of the vehicle to transport the equipment creates a number of problems. For instance the lack of available space can be particularly a problem when there are several individuals with their associated equipment involved, especially if there is any significant distance to be traveled. Also, the view of the driver can be easily obstructed by the equipment. There is also a problem associated with damage to the equipment since the vehicle interior is seldom designed to accommodate such equipment. The security of the equipment is also an issue when the vehicle is left unattended, particularly overnight, since it is normally noticeable through the windows of the vehicle.

The use of truck beds, such as pick-up cargo beds, also have problems with taking up significant amounts of cargo space as well as the security of the equipment left in the cargo bed. Also, the frequency of loading and unloading of the equipment may also create problems.

These issues are particularly a problem for certain equipment such as electrical generators. Electrical generators are often desired and even necessary in many situations. One particular situation is the use of generators with recreational vehicles and work vehicles. These generators are widely used for providing AC power to operate appliances within recreational vehicles as well as to provide power to operate commercial equipment such as for vendors or for work site equipment such as lighting and other uses.

The use of these generators with recreational vehicles is often problematic. The generators must usually be factory installed within a special compartment within the body of the recreational vehicle. These compartments must provide for ventilation and take up considerable space which is at a premium. Often, these generators are omitted from the vehicle in order to save space and expense. The vehicle is then operated with an external outlet for connection to an external AC power source.

Also, the noise from the operation of these generators can be annoying. The fumes from the exhaust as well as from the fuel can also be a problem with the use in enclosed areas.

The use of these generators with commercial or work vehicles is also a problem. Normally these types of vehicles are already crowded with equipment. The generator is usually removed from the vehicle for use at a worksite. These generators are relatively heavy and cumbersome to load and unload from the vehicle. None of the prior carrier systems satisfactorily provided the ease of transporting equipment, the security and the convenience of storage of equipment that is desired. It is therefore desirable to provide such a device that will allow equipment, such as an electrical generator as well as other recreational and work equipment, to be easily and securely transported and stored between locations.

### SUMMARY OF THE INVENTION

The present invention accomplishes those needs by providing a system of carriers for transporting portable electrical generators. The carriers of the present invention proves a secure and efficient device for transporting such equipment in a secure manner. The carriers of the present invention are able to be mounted behind most vehicles with little loss in speed or maneuverability.

A preferred embodiment of the present invention provides a generator platform deck that is mounted onto a frame that engages in a vehicular receiver hitch. A cover is secured over the platform deck to provide environmental protection for the generator as well as sound insulation during operation of the generator.

Another preferred embodiment of the present invention is to mount the generator deck onto a frame that engages in a hitch receiver of a vehicle. The frame includes a telescoping section to allow the compartment to be moved rearwardly to allow access into the vehicle without removing the compartment from the vehicle. Wheeled stands are pivotally attached to the bottom of the platform to be moved into position to support the carrier when the carrier is removed from the vehicle.

In another preferred embodiment, the generator deck is mounted onto a trailer surface. One embodiment mounts the generator deck to the roof surface of a trailer or other vehicle while another embodiment mounts the generator deck to the A frame section on a trailer.

The carrier system of a preferred embodiment provides a generator deck platform that is heat resistant from the operation of the generator. One embodiment utilizes a plywood section that is coated with encapsulated polyurethane. Other embodiments use ABS or other types of heat resistant plastics.

A preferred embodiment of the present invention includes electrical and fuel connections mounted to the system to allow connections between the generator and electrical power cords and fuel supplies. Weatherproof connections are formed in the generator deck platform for the electrical and fuel lines.

A preferred embodiment provides a cover for protecting the generator as well as providing sound insulation. One embodiment uses a pivotally mounted cover for ease of access to the generator. Other embodiments include a cover that easily removable from the deck.

These and other features of the present invention are evident from the drawings along with the detailed description of preferred embodiments.

### BRIEF DESCRIPTION OF THE DRAWINGS

FIG. 1 is a perspective view of the carrier frame of the generator carrier system of a preferred embodiment of the present invention.

FIG. 2 is a perspective view of assembled carrier frame of the embodiment of FIG. 1.

FIG. 3 is a perspective view of the carrier system of a preferred embodiment of the present invention.

FIG. 4 is a perspective view of the carrier system of FIG. 3 mounted to a vehicle with a generator.

FIG. 5 is a perspective view of the carrier system of FIG. 3 in with the wheels extended and moved away from the vehicle.

FIG. 6 is a perspective view of another preferred embodiment of the present invention attached to a recreational vehicle.

FIG. 7 is a perspective view of the embodiment of FIG. 6 with the cover opened.

FIG. 8 is a perspective view of the embodiment of FIG. 6 with the electrical lines plugged into the vehicle.

FIG. 9 is a perspective view of the embodiment of FIG. 6 with the wheels extended and the carrier moved away from the vehicle.

FIG. 10 is a perspective view of another preferred embodiment of the present invention mounted on the roof of a trailer or other vehicle.

FIG. 11 is a perspective view of the embodiment of FIG. 10 with the cover removed.

FIG. 12 is a perspective view of another embodiment of the present invention mounted on the A framework of a trailer.

FIG. 13 is a perspective view of the embodiment of FIG. 12 with the cover attached.

FIG. 14 is a perspective view of the embodiment of FIG. 12 with the cover partially exposed.

### DETAILED DESCRIPTION OF A PREFERRED EMBODIMENT

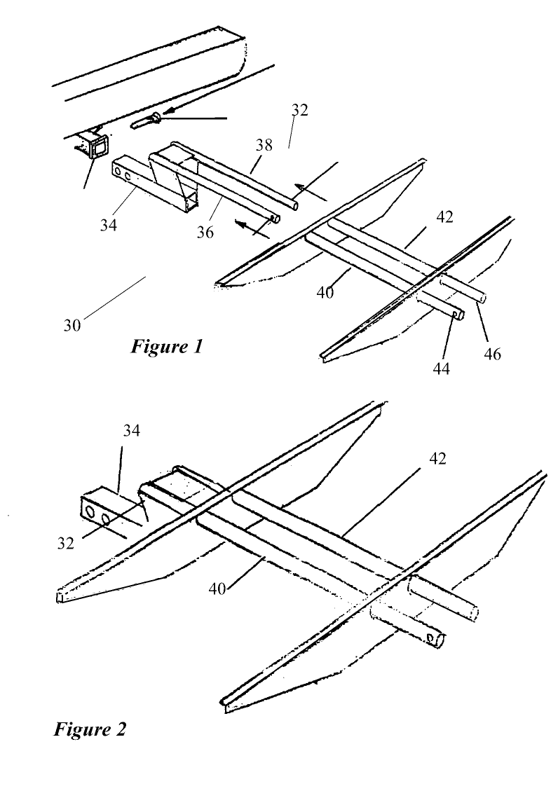

Referring in more detail to the drawings, as shown in FIGS. 1-4, a preferred embodiment of the present invention is described. It is to be expressly understood that this exemplary embodiment is provided for descriptive purposes only and is not meant to unduly limit the scope of the present inventive concept. Other embodiments and variations of the carriers of the present invention are considered within the present inventive concept as set forth of the claims herein. For explanatory purposes only, the carriers of the preferred embodiments are discussed primarily for use with cargo. It is to be expressly understood that other types of equipment are contemplated for use with the present invention as well.

The present invention relates to the subject matter of application Ser. No. 09/788,299, filed on Feb. 16, 2001; Ser. No. 09/336,887, filed on Jun. 18, 1999 which issued as U.S. Pat. No. 6,213,539; and Ser. No. 09/100,808, filed on Jun. 19, 1998 which issued as U.S. Pat. No. 6,042,175, all of which are incorporated herein by reference.

A preferred embodiment of the present invention is illustrated in FIGS. 1-4. This preferred embodiment provides a carrier system for an electrical generator such as the commonly distributed electrical generators by Onan, Coleman, Yamaha, Brigs-Stratton, DeWalt, Generac, Honda and other manufacturers and distributors of portable electrical generators. It is to be expressly understood that the present invention is not to be limited to a particular model or manufacturer of generator.

The carrier system 10, as shown in FIG. 1, includes a platform 20 mounted on a hitch carrier system 30, such as the hitch carrier system disclosed in U.S. patent application Ser. No. 09683820, incorporated herein by reference. The hitch carrier system 30, in this preferred embodiment, includes frame 32 having a receiver hitch 34 for insertion into a vehicle receiver. Two parallel connection tubes 36, 38 are mounted onto the hitch receiver 34. Two frame members 40, 42 are slidably received over the connection tubes 36, 38. The frame members 40, 42 are secured to the parallel connection tubes 36, 38 by pins 44, 46. It is to be expressly understood that other hitch carrier systems may be used, including single frame carriers, ball mounted hitch receivers and any other type of carrier system.

In this preferred embodiment, the frame members 40, 42 can slide relative to the connection tubes. This allows access to the rear of the vehicle even while the generator deck as described below is mounted on the hitch receiver of the vehicle. If access is desired into the rear of the vehicle, the pins 44, 46 are removed and frame members 40, 42 are slid rearward relative to connection tubes 36, 38 a sufficient distance to allow the rear tailgate to be lowered. Once the tailgate is closed, the generator deck and frame members are slid towards the vehicle until the pins 44, 46 can be reinserted.

The system of this embodiment includes a generator deck 60. Generator deck 60 is attached to the frame system 50 of the carrier system. In this preferred embodiment, the generator deck is a composite deck. A plywood layer is coated with an encapsulated polyurethane coating. Alternatively, the generator deck can be formed from an ABS plastic or high density polyethylene. The composite polyurethane deck, the ABS plastic deck or other materials with high temperature resistance characteristics are preferred for superior heat characteristics. It is to be expressly understood that other types of materials may be selected as well such as but not limited to steel gratings, stainless steel, aluminum sheeting and other plastics or materials.

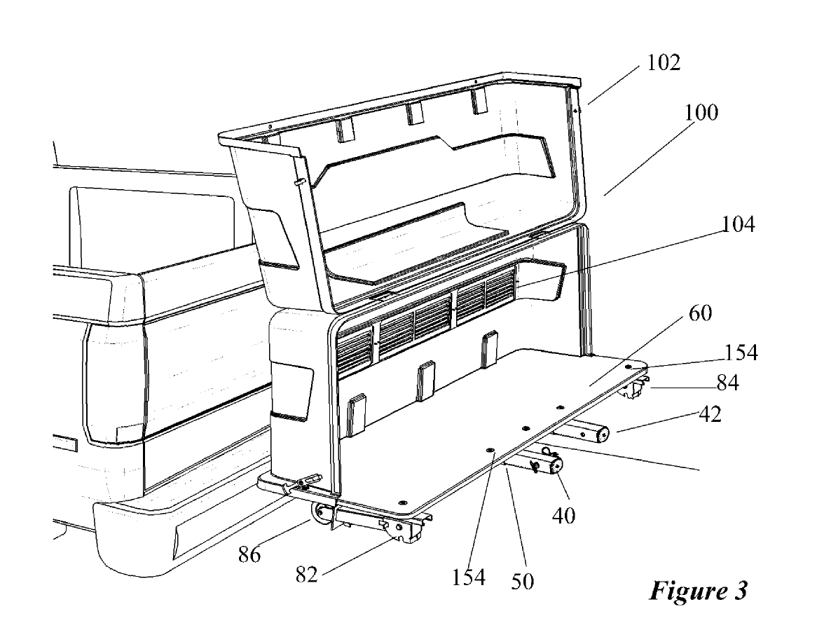

The generator deck 60 may formed as a flat deck as shown in FIG. 3 or it may be formed as a tray with upturned edges. In the preferred embodiment, a series of holes are formed in the generator deck. These holes include an access hole for electrical power lines from a generator mounted on the deck 60 and drainage holes for fluids such as water, oil, gasoline or other liquids to drain from the deck 60. Also, mounting holes are formed through the deck to mount the generator to the deck as well as to mount the deck onto the wings or frames of the carrier system.

In another preferred embodiment, the generator deck may also include electrical connectors to enable connection between the generator and the electrical power lines. This could also include an electric junction box 62 and/or weatherproof connectors. Quick disconnect fuel receptacles 64 may also be incorporated into the generator deck system.

In the preferred embodiment illustrated in FIGS. 3-5, the gear deck 60 also includes retractable extendable support legs 80, 82, 84. These legs include rolling wheels 86, 88, 90. The legs are normally retracted out of the way by pivoting upward into a locked position against the bottom surface of the generator deck. The legs are then pivoted downward as shown in FIG. 5 to allow the generator deck to be moved away from vehicle to which it has been attached. This is particularly useful for generators used at a worksite, at a campsite or other sites where the generator is used in a standalone manner away from the vehicle. It is also useful for storage of the generator when not in use.

The generator deck 60 also includes a cover 100. The cover 100 in a preferred embodiment includes a clamshell design which allows the front portion 102 of the cover to be pivoted up and out of the way in order to access the generator. It is to be expressly understood that the cover may also be in one-piece and completely removable or it may be multi-segmented. The cover is designed to protect the generator from the environment as well as to provide sound insulation.

The cover 100 may formed or attached integrally with the deck 60 or it may be removably attached as shown in FIG. 3 by securing mechanisms 106. The cover may be formed of plastic such as high density polyethylene or ABS or other suitable materials. Preferably, the cover includes ventilation grills 104 formed in the cover to allow inlet air and exhaust gases during the operation of the generator. Also, the ventilation is desirable if fuel is stored within the cover.

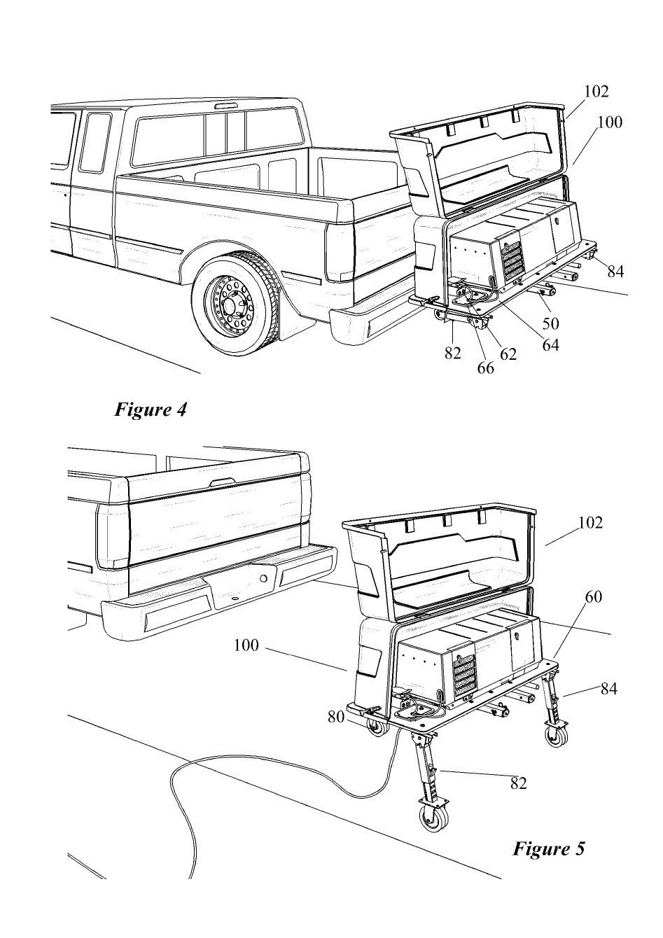

The preferred embodiment as shown in FIGS. 3-5 may be used in the hitch receiver of a pick-up, a truck, SUV, or other vehicles. The embodiment as shown in FIGS. 3-5 is particularly suitable for use on work sites or other locations. The generator deck may be used either while installed on the hitch receiver of the vehicle as shown in FIG. 4, or it may be brought to the site and then removed for use or storage.

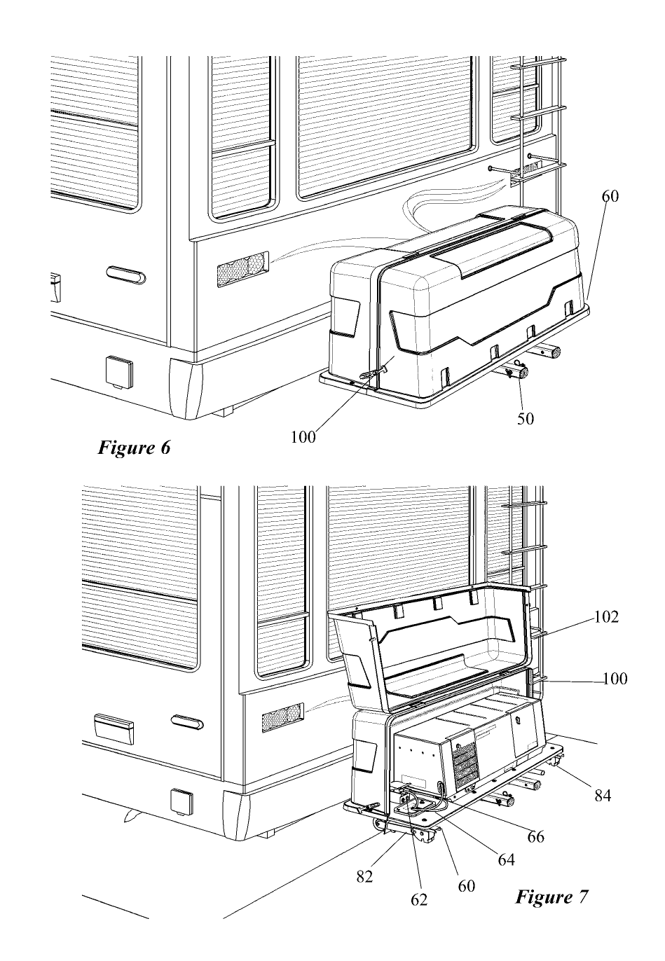

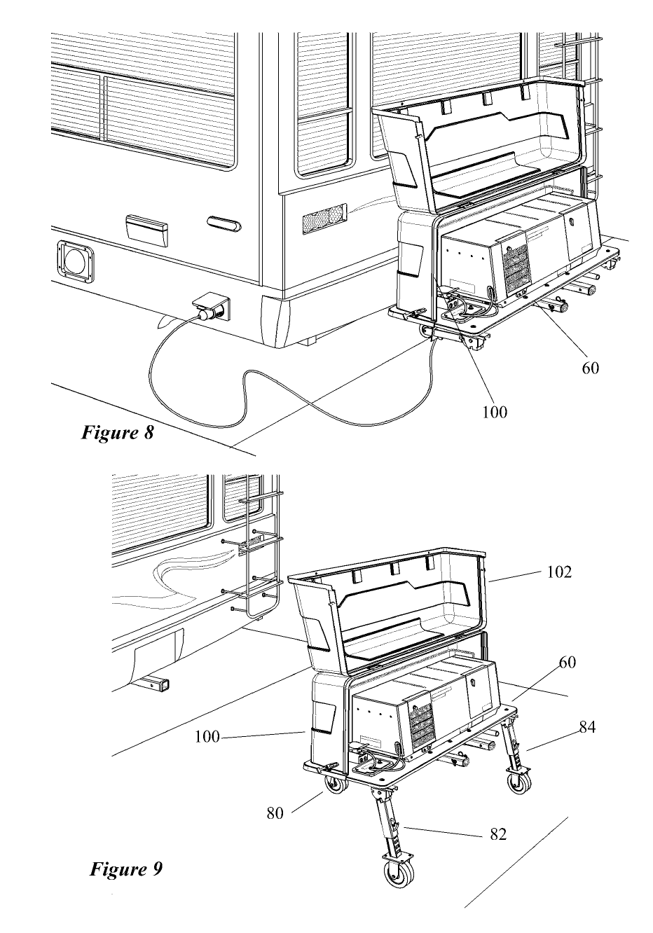

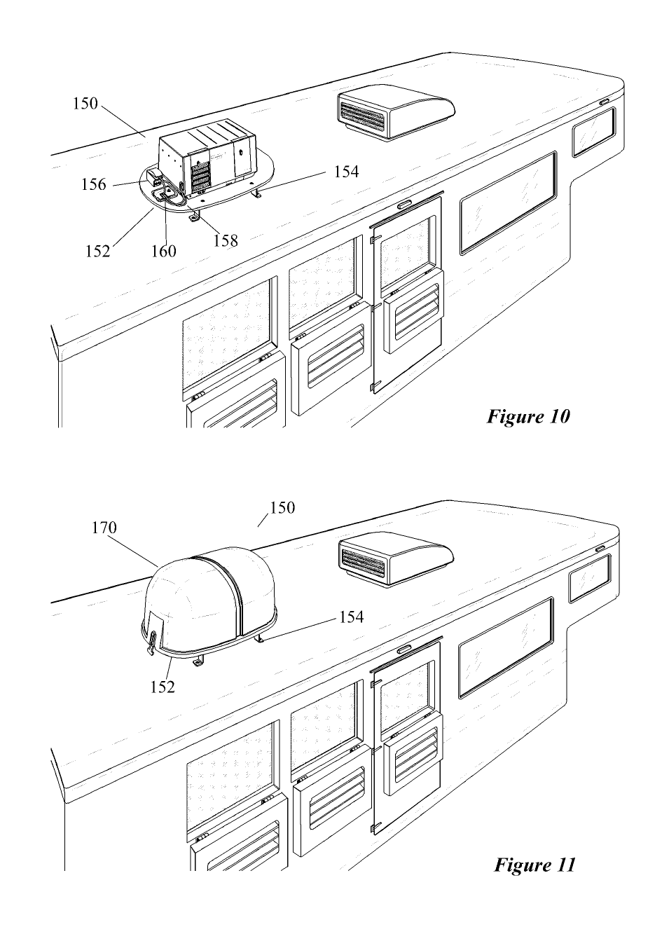

Another preferred embodiment of the present invention is illustrated in FIGS. 6-9. This embodiment is useful for use with recreation vehicles, motor coaches, travel trailers or other types of recreational vehicles and trailers. The generator deck 60 as discussed above is mounted on the hitch receiver or even secured to the bumper of the vehicle as shown in FIG. 6. The electrical lines of the generator can be plugged into the 110 AC receptacle of the vehicle as shown in FIG. 8. This supplements or replaces the generator that is typically used in such vehicles or can be used in the event that such a generator is not mounted in the vehicle. The generator may be moved away from the vehicle by the extended legs as shown in FIG. 9 for storage or for use with another vehicle or location.

Another preferred embodiment of the present invention is illustrated in FIGS. 10 and 11. This embodiment utilizes a generator deck system 150 mounted onto the roof of a horse trailer, a recreational vehicle or other vehicle surface. The generator deck 152 is formed from a composite plywood coated with encapsulated polyurethane or heat resistant materials, from ABS plastic, steel grating, stainless steel, aluminum sheets or other structural materials. The generator deck 152 is bolted directly to the vehicle surface by brackets 154. An electrical receptacle 156 is mounted to the generator deck to allow ease of connection. Quick disconnect fuel connectors 158 are also included as well. The electrical power lines are inserted through weatherproof receptacles 160 formed in the generator deck as well as the fuel lines.

Cover 170 is secured over the generator deck 152 to protect it from the environment and to provide sound insulation. The cover 170 is easily removed to access the generator 180 mounted to the generator deck. The cover 170 in this embodiment may be small and more aerodynamic than the cover that was previously described.

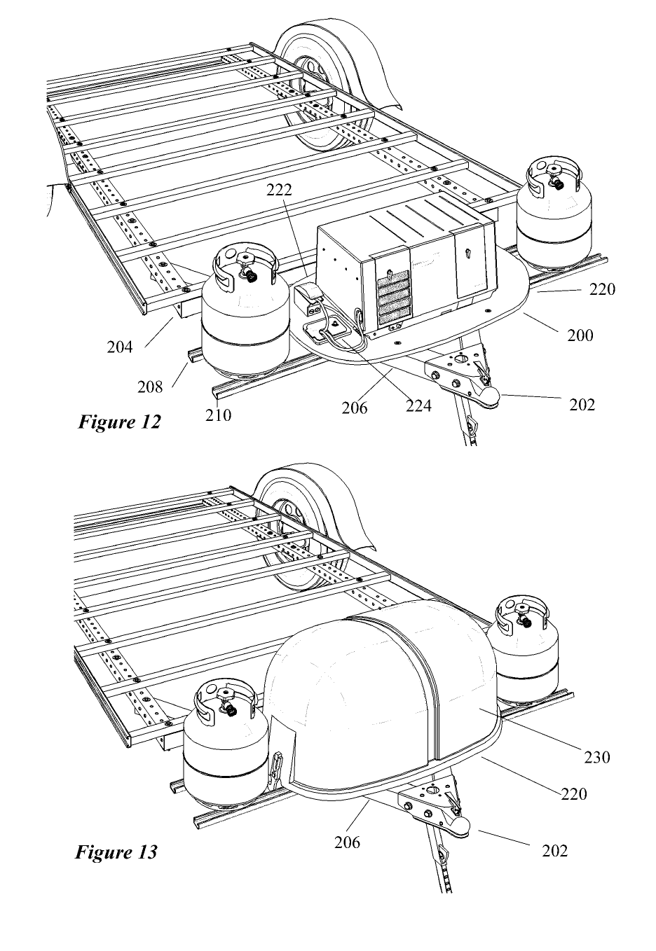

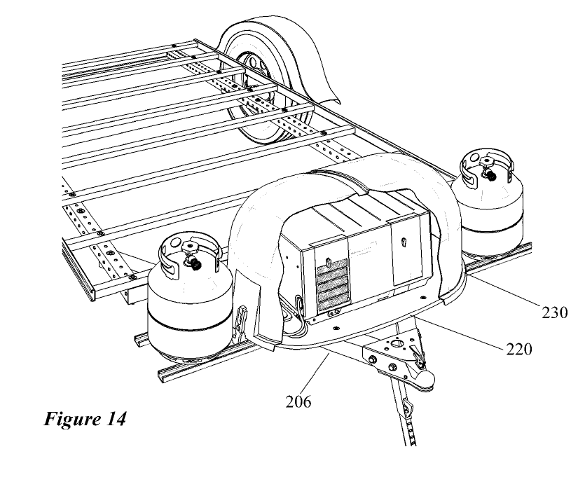

Another alternative embodiment is illustrated in FIGS. 12-14. This system 200 is mounted on the A frame extending between a trailer hitch 202 and the trailer body 204. This system 200 includes a generator deck 220 mounted on frame members 208, 210 that are secured to the A frame 206 of the trailer. The generator deck 200 is similar to the above described generator decks and is formed from plywood coated with encapsulated polyurethane, ABS plastic or other structural materials such as but not limited to steel grating, stainless steel, aluminum sheeting, or other plastics. The generator deck includes electrical receptacle box 222, quick disconnect fuel connectors and weatherproof drain and inlet holes 224. A cover 230 is secured to the generator deck to protect the generator from the environment as well as to provide sound insulation during use of the generator.

The present inventive concept, as set forth in the accompanying claims, covers not only the described embodiments but other embodiments, variations and configurations of the generator carrier system as stated in the accompanying claims. The present invention may include other embodiments that may be secured to hitch receivers, directly to hitches, directly mounted to bumper, carriage or frame systems, onto trailers, boats, vehicles or any other surface as may be desired or as a stand-alone system.

What is claimed is:

1. A carrier system for transporting portable electrical generators, said carrier system comprising:
a deck platform formed of heat resistant materials;
a cover secured to said deck for protecting a generator from the environment and for providing sound insulation during the operation of the generator; and
a mechanism for attaching said deck platform to a vehicle.

2. The carrier system of claim 1 wherein said mechanism for attaching said deck platform to a vehicle includes:
a receiver member removable engageable in a hitch receiver of a vehicle.

3. The carrier system of claim 1 wherein said mechanism for attaching said deck platform to a vehicle includes:
a bracket system for securing said deck platform onto a surface of the vehicle.

4. The carrier system of claim 1 wherein said mechanism for attaching said deck platform to a vehicle includes:
said vehicle includes a trailer; and
a bracket system for securing said deck platform onto a surface of the trailer.

5. The carrier system of claim 1 wherein said mechanism for attaching said deck platform to a vehicle includes:
said vehicle includes a trailer having an A frame section between the trailer body and the trailer hitch; and
a bracket system for securing said deck platform onto said A frame section of the trailer.

6. The carrier system of claim 1 wherein said platform deck includes:
a plywood section; and
a heat resistant coating on said plywood section.

7. The carrier system of claim 1 wherein said platform deck includes:
a plywood section; and
an encapsulated polyurethane coating on said plywood section.

8. The carrier system of claim 1 wherein said platform deck includes:
a section formed from ABS plastic.

9. The carrier system of claim 1 wherein said platform deck includes:
an electrical receptacle for providing electrical connection between a generator mounted on said platform deck and electrical power cords.

10. The carrier system of claim 1 wherein said platform deck includes:
quick disconnect fuel connections for providing connections between a generator mounted on said platform deck and fuel supplies.

11. The carrier system of claim 1 wherein said platform deck includes:
weather proof inlet holes for electrical and fuel lines to enter said platform deck.

12. The carrier system of claim 1 wherein said platform deck includes:
drainage holes for allowing fluids to drain from said platform deck.

13. The carrier system of claim 1 wherein said cover includes:
a ventilation system to allow inlet air to enter said cover and exhaust gases to exit said cover.

14. The carrier system of claim 1 wherein said cover includes:
a clam shell design to allow a front portion cover to be opened to allow access to a generator mounted on said platform deck.

15. The carrier system of claim 1 wherein said carrier system further includes:
retractable legs that may be moved from a retracted position to an extended position; and
wheels on said retractable legs for allowing said carrier system to be moved away from the vehicle.
